(19) United States
(12) Patent Application Publication
(10) Pub. No.: US 2021/0101041 A1
(43) Pub. Date: Apr. 8, 2021

(54) TRAMPOLINE SCOOTER

(71) Applicant: FLEET ACTION SPORTS LIMITED, GLOUCESTER (GB)

(72) Inventors: BENJAMIN WILKINSON, GLOUCESTER (GB); JERRY NORMAN, GLOUCESTER (GB)

(73) Assignee: FLEET ACTION SPORTS LIMITED, GLOUCESTER (GB)

(21) Appl. No.: 16/970,182

(22) PCT Filed: Feb. 18, 2019
(86) PCT No.: PCT/GB2019/050415

§ 371 Date: Aug. 14, 2020

(30) Foreign Application Priority Data
Feb. 16, 2018 (GB) 1802566.8

(51) Int. Cl. A63B 5/11; A63B 69/00; B62K 3/00

(52) U.S. Cl. CPC A63B 5/11; A63B 21/4034; B62K 3/002; A63B 69/0093

(57) ABSTRACT

There is provided a trampoline scooter (10) includes an elongate deck (12) including an upper surface (12a), a convex lower surface (12b), and rounded lateral edges (16) provided between the upper and lower surfaces (12a, 12b) for engaging a trampoline, a head tube (20) connected to the deck (12), and a column (22) disposed through the head tube (20), an upper end of the column (22) extending beyond the head tube (20) for receiving a set of handle bars.

### BACKGROUND TO THE INVENTION

Push scooters (or kick scooters) are used recreationally and competitively to perform stunts. Where available, stunts can be practised in a skate park or arena, where custom obstacles including ramps and rails are provided. Whether or not safety gear such as helmets and pads are worn, there is an element of risk in any stunt (like a jump or a trick) and injuries do occur. This is a particular issue when learning a new stunt.

To practise stunts in a safer manner, it is possible to practise jumps and tricks on a trampoline. If the scooter is not landed properly at the end of the stunt, the person falls onto the trampoline jumping mat and remains uninjured in almost all cases. However, a trampoline jumping mat is easily damaged by a scooter, from sharp edges on the scooter deck, as well as other objects such as the wheels. Higher jumps increase the force exerted on landing, and increase the likelihood of damage being caused. It is expensive and time-consuming to replace the jumping mat of a trampoline.

It is possible to cover a scooter in duct tape to minimise damage to a trampoline during use. However, even if multiple layers of tape are used, the tape does not always redistribute pressure evenly and it can be ripped over sharp protrusions on landing a stunt, potentially damaging the jumping mat. Furthermore, the tape has to be removed to use the scooter normally afterwards, and leaves a sticky residue which must be cleaned off. Other modifications such as partial disassembly of the scooter are time-consuming and reassembly is needed to use the scooter away from the trampoline.

It is an object of the present invention to provide a scooter which reduces or substantially obviates the aforementioned problems.

### STATEMENT OF INVENTION

According to the present invention, there is provided a trampoline scooter comprising
an elongate deck including an upper surface, a convex lower surface, and rounded lateral edges provided between the upper and lower surfaces for engaging a trampoline,
a head tube connected to the deck, and
a column disposed through the head tube, an upper end of the column extending beyond the head tube for receiving a set of handle bars.

The trampoline scooter is ideally suited to practising scooter stunts on a trampoline without damaging the trampoline. The convex lower surface provides an increased surface area (relative to a flat surface) for distributing pressure evenly over the jumping mat. There is no need to wrap the scooter in duct tape (or subsequently remove the tape and residue) because the lower surface and lateral edges of the deck are smooth and rounded to avoid tearing the jumping mat. The scooter has no wheels at the front or back. So, the scooter is only suited for practising stunt work on a trampoline, where momentum can be generated without wheels.

Whilst the weight distribution of the trampoline scooter is broadly similar to a wheeled scooter, it may be adapted or modified to substantially replicate the weight distribution for a wheeled scooter. It may be specifically adapted to substantially replicate the weight distribution of a specific make or model of wheeled scooter. This may be achieved by constructing the deck, head tube, column and/or other parts to closely approximate a wheeled scooter, and/or by adding ballast, whilst compensating for the lack of wheels and related elements. Mimicking the weight distribution of a wheeled scooter better simulates a real stunt scenario, improving the relevance of the trampoline scooter as a stunt training scooter.

A lower end of the column may include a foot for engaging the trampoline. The foot may be disposed adjacent to the deck. In other words, the foot may be located in a lateral plane of the deck. The foot may be provided in place of having a front wheel. In other words, the foot is located underneath the head tube.

A front end or front end region of the deck may be positioned underneath the head tube and the column. That is, the front end or region of the deck may be vertically below the head tube and column when the scooter is upright. This is preferred where a foot is not provided.

The head tube connection to the deck may be spaced from or inset from the rounded lateral edge at the front end of the deck. The deck may effectively project or extend forwards to a position below the head tube and column. That is, the front end of the deck may be disposed in a region where a foot may otherwise have been provided. This is useful where the scooter is being used as an introductory-level trampoline scooter.

The projection/extension of the deck does not necessarily mean that anything has been appended to the deck. Rather, the connection point of the head tube to the deck may affect the degree to which the front end of the deck juts forward. The deck is preferably formed as a single piece for maximum strength. In other words, instead of having a ‘normal’ foot on the column, the front end of the deck extended to under the column can act as a foot.

A lower end of the column may be disposed above (or terminate above) a lateral plane through the deck. This is preferred where the column does not include a foot, although in some cases the foot or column may be moveable in order raise the foot to a position above the lateral plane of the deck so that it does not engage a trampoline during use.

In other words, when the scooter is in an upright position, the column and head tube do not extend to the level of the deck. In use, the deck may be the only part of the trampoline scooter which contacts the trampoline. This is again useful where an introductory-level scooter is desired.

If the deck projects to under the head tube and column, the column may include a nub. In other words, the column may include a nub fork or bottom-locking fork. The nub may be rounded, for example like a hemisphere or flattened hemisphere. The column functions like it would if a “normal” fork were provided. That is, the column (and handle bars in use) can rotate in the head tube.

The head tube may connect to the deck via a support member or neck. The support member or neck may extend at an oblique angle away from the lateral plane of the deck. The support member or neck may connect next to the rounded lateral edge at the front end of the deck. Alternatively, the support member or neck may connect to the rounded lateral edge at a position which is spaced from or inset from the front end of the deck. Preferably the neck is positioned centrally between the rounded side edges of the deck. Preferably the neck extends parallel to the rounded side edges.

The upper surface of the deck may include a protrusion or raised member which serves as an imitation (or dummy) brake. The protrusion may be considered to be a rounded prominence or protuberance. The protrusion may provide a dome-like raised area (or wedge-like raised area) as a dummy brake. The raised area may slope to the deck at front and rear sections. In other words, the upper surface may comprise a non-flexing imitation fender, to simulate the inflexibility of a wheel under a brake fender. This allows the user to ‘apply’ the brake and manipulate the deck, when practising for a slide, for example. The dummy brake may be removable. The dummy brake or fender may be provided at or towards the rear of the deck, at the opposite end to the head tube, where it would usually be located for a wheeled scooter.

The trampoline scooter may comprise a set of handle bars. The handle bars may be connected to the column by releasable connection means, which may include e.g. a headset. This allows the handle bars to be interchangeable. Users often have a custom set of bars that they practise with. Thus, the same trampoline scooter can be customised for use by different people.

The handle bars may instead be integrally formed with the column. This may be preferred where the column does not extend to the level of the deck. In other words, it may be preferred when there is no foot, or where the foot is moved to a position above the level of the deck so it is not trampoline-engaging during use.

A clamp may be provided on the column, above the head tube. The clamp may include a compression system. The clamp may include a HIC system. The clamp may hold the column and handle bars together when tightened around both. For example, around a bottom section of a steering column which is engaged with the column through the head tube.

The rounded lateral edges may form a continuous periphery around the front, rear and sides of the deck. This smooths out the corners of the deck, so to minimise any sharp points or regions that could damage the trampoline, particularly the jumping mat.

Preferably, the convex lower surface curves from one side edge of the deck to the other.

The convex lower surface may curve from a front edge of the deck to a rear edge of the deck. The convex lower surface may be curved both side-to-side and front-to-rear.

The convex lower surface may have a substantially constant radius of curvature. The deck may increase in thickness towards the centre of the deck due to the convex nature of the lower surface. The rounded lateral edges may reach a maximum lateral extent in a middle third of the deck, between the upper and lower surfaces. The rounded lateral edges may reach a maximum lateral extent in a region about halfway between the upper and lower surfaces. The thickness of the deck at its centre may be about double the thickness of the deck at its side edge (particularly the maximum lateral extent of the sides edge).

Another way of considering the deck thickness is as follows. From a plane running tangential to a maxima of the convex lower surface, the distance to a parallel plane of the upper surface is about double that of the distance to a parallel plane through the deck at its widest points. This ‘doubling’ of thickness applies if the side edges peak about halfway through the deck, but if the side edges peak closer to one or other of the upper/lower surfaces then the relative change in thickness varies accordingly. If a more convex lower surface is used, the widest points of the deck may be closer to the upper surface and further from the maxima of the lower surface, so that the increase in thickness towards the centre of the deck is more than double, and vice versa.

The lower surface of the deck may include a substantially uniform surface without protrusions. In other words, the lower surface may be a continuous/uninterrupted curved surface. The convex lower surface may be shaped like part of a curved cylindrical surface. If the convex lower surface is curved side-to-side and front-to-rear, the surface may be shaped like part of an ellipsoid surface. This results in even pressure distribution when landing a stunt on a trampoline. This avoids providing any sharp points or regions which could damage the trampoline, particularly the jumping mat.

The convex lower surface may be curved about a longitudinal axis of the deck. That is, about an axis running from front to back ends of the deck. This gives side-to-side curvature.

The deck may comprise a plate receiving area for releasably holding a plate. When a plate is connected to the deck, it may form part or all of the convex lower surface. If the plate forms part of the lower surface, it lies substantially flush with the rest of the lower surface when connected. This allows a user to customise the aesthetic appearance of the deck, which is visible when airborne during a stunt. It also allows the user to customise the slidability of the deck, by selecting a plate with a particular coating or made of a particular material. This can improve their feel for the behaviour of the trampoline scooter when performing a stunt.

The upper surface of the elongate deck may include or be at least partly covered by a grip layer. This provides an improved foothold for performing stunts, particularly on landing. The grip layer may cover substantially all of the upper surface. Where an imitation brake is provided, the grip layer may not cover the imitation brake. This better simulates the feel of a real brake on a wheeled scooter.

The grip layer may include a rubberised material. The grip layer may have a high coefficient of friction relative to materials expected to be in contact with the layer during use, e.g. the sole of a shoe. The rubberised material may have a rough surface, which may have a high coefficient of friction. The grip layer may include grip tape. The coefficient of friction of the grip layer, where provided, is higher than the coefficient of friction of the deck. The grip layer may be removable, for replacement by a new grip layer. The grip layer may be adapted or modified to maximise grip for socks or bare feet. This is because shoes are typically not worn on trampolines, due to the risk of tearing and ingraining dirt in the jumping mat.

The upper surface of the deck may be flat or may be concave. Where provided, the dummy brake extends from the flat or concave surface. The concave curvature of the deck may be 5° or less. Preferably, the concave curvature of the deck is about 3°. This provides improved grip for performing stunts, particularly on landing.

The convex lower surface and/or the foot may each comprise a material with a low coefficient of friction for engaging the trampoline. The convex lower surface and/or the foot may be smooth or have a smooth trampoline-engaging surface or area. The convex lower surface and/or the foot may comprise a tungsten carbide surface for engaging the trampoline. In other words, providing a low friction surface improves the glide or slidability of the deck over the jumping mat. This reduces the likelihood of tearing the jumping mat when performing a stunt. This includes movement of the deck on the mat when generating momentum to jump, and movement of the deck on the jumping mat on landing.

The foot may comprise at least one upright member. A horizontal member may be connected to the upright member. The horizontal member may be integrally formed with the or each upright member for strengthening the foot. The horizontal member may be disposed in substantially the same plane as the deck, which is also horizontal when in engagement with a trampoline. The horizontal member may include rounded first and second ends, and rounded sides between those ends, for engaging the trampoline.

The upright and horizontal members provide a front end which is adapted to engage a trampoline without ripping it. The ends and edges of the horizontal bar are rounded in a similar manner to the edges of the deck. The size and shape of the parts of the foot can be customised to adjust the weight of the front end and fine tune the ‘feel’ of the scooter for stunt work. The horizontal member generally engages the trampoline at the same time as the deck, for example when initially beginning stunt work and gaining height, or when landing a trick. Thus, having the horizontal member in the plane of the deck improves control in these situations.

Two upright members may be provided. The horizontal member may join distal ends of the upright members together to form a fused fork unit. This mimics the fork arrangement of a wheeled scooter, and so more closely approximates the weight distribution of a scooter which will be used for tricks away from a trampoline.

The foot may curve away from an axis of the column with increasing distance from the head tube. When the deck and foot both engage the trampoline, the fabric of the jumping mat is most deformed under the deck, but the mat at the foot is sloped towards the deepest point of the jumping mat. The foot is curved outwardly to maximise engagement with the sloped mat. It may also improve control for a user or rider when landing a trick on or pivoting on the front end.

Similarly, the lowermost surface of the foot may lie slightly higher than the lowermost surface of the deck, to account for the curvature of the jumping mat when the weight of the scooter (and rider) deforms the mat.

The foot may comprise a ball. This makes practice with the trampoline scooter more realistic for learning to perform stunts on a wheeled scooter. The ball also provides even support in all directions when landing and/or pivoting the scooter on the foot.

The ball may be made of solid plastic or solid rubber. Using a solid ball provides a weighted front end, which better simulates feel for the weight distribution of a normal scooter with fork and front wheel.

The diameter of the ball may be greater than a diameter of the head tube. This maximises the surface area of the foot, with a corresponding distribution of pressure through the foot, reducing peak pressure on the trampoline. Having a foot of similar width to the deck provides improved stability and control during stunt practice.

According to a second aspect of the present invention, there is provided a kit of parts for a trampoline scooter, the kit comprising:
an elongate deck including an upper surface, a convex lower surface, and rounded lateral edges provided between the upper and lower surfaces for engaging a trampoline, and a head tube connected or connectable to the deck; and
a column which is adapted to fit through the head tube, such that in use an upper end of the column extends beyond the head tube, the upper end of the column being adapted for receiving a set of handle bars.

At least one part of the trampoline scooter may comprise one or more features described in relation to the first aspect of the invention. The advantages of the trampoline scooter kit are the same as set out for the first aspect of the invention.

According to a third aspect of the invention, there is provided a trampoline scooter comprising an elongate deck including an upper surface, a convex lower surface, and rounded lateral edges provided between the upper and lower surfaces for engaging a trampoline, a head tube connected to the deck, and a column disposed through the head tube, one end of the column including a foot for engaging the trampoline, the foot being disposed adjacent to the deck, and the other end of the column extending beyond the head tube for receiving a set of handle bars.

The third aspect of the invention may include any feature or combination of features presented in claim 2 or 6-27.

According to a fourth aspect of the invention, there is provided a kit of parts for a trampoline scooter, the kit comprising at least one of the following: an elongate deck including an upper surface, a convex lower surface, and rounded lateral edges provided between the upper and lower surfaces for engaging a trampoline, and a head tube connected to the deck; and a column which at one end includes a foot for engaging a trampoline, and adapted at another end for receiving a set of handle bars, the column being adapted to, in use, fit through and extend beyond a head tube into a position where the foot is disposed adjacent to a deck.

The fourth aspect of the invention may include any feature or combination of features presented in claim 2 or 6-27.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows an upper perspective view of a trampoline scooter according to the present invention;

FIG. 2 shows a lower perspective view of the trampoline scooter of FIG. 1;

FIG. 3 shows a side view of the trampoline scooter of FIG. 1;

FIG. 4 shows a top view of the trampoline scooter of FIG. 1;

FIG. 5 shows a front view of the trampoline scooter of FIG. 1;

FIG. 6 shows a perspective view of a second embodiment of a trampoline scooter;

FIG. 7 shows a side view of the trampoline scooter of FIG. 6; and

FIG. 8 shows an exploded perspective view of a column and head tube of the trampoline scooter of FIG. 6.

### DESCRIPTION OF PREFERRED EMBODIMENTS

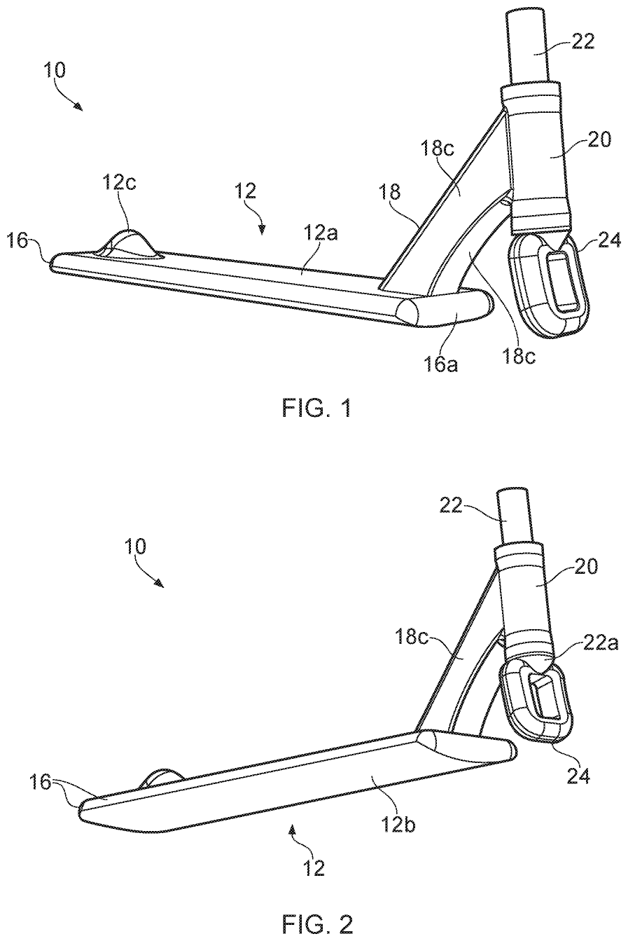

Referring to FIGS. 1 to 5, an exemplary embodiment of a trampoline scooter is indicated generally at 10. The scooter 10 can be constructed by additive manufacturing (also known as 3D printing) or subtractive manufacturing in this embodiment. The scooter 10 is intended for use with a trampoline (not shown). Ideally the trampoline should be a few metres in diameter to practise stunts safely, lowering the risk of injury if it goes wrong.

The scooter 10 includes an elongate deck 12. The bulk of the deck 12 is mainly made of aluminium in this embodiment. An upper surface 12a of the deck 12 is covered in grip tape 14 in this embodiment to provide a high friction surface for standing on. A lower surface or underside 12b of the deck 12 is made of plastic to provide a low friction surface for engaging a trampoline. In this embodiment, the underside 12b of the deck 12 is not removable. The upper surface 12a is substantially flat in this embodiment.

The deck 12 includes a raised area (or hump) 12c as an imitation brake on the upper surface 12a. The raised area 12c is not covered in the grip tape 14 in this embodiment. The raised area 12c is provided centrally and inset from the rear end of the deck 12. The top of the raised area 12c is rounded. The raised area 12c is substantially oval-shaped when viewed from above (see FIG. 4).

The raised area 12c is an elongate bump or dome with leading and trailing slopes. The sides of the raised area 12c also slope, but at a steeper angle than the front and rear of the raised area 12c. This makes the dummy brake longer than it is wide, along the length of the deck 12. This simulates the shape of a fender and underlying rear wheel on a wheeled scooter. The raised area 12c is an integral part of the deck 12. The dummy brake is not flexible in this embodiment, but may have some flex in other embodiments.

The deck 12 is substantially symmetric about a central vertical plane A through the scooter 10. The underside 12b is convex, best seen in FIG. 5. The radius of curvature of the underside 12b is constant in this embodiment. The lower surface 12b is substantially uniform and smooth, without any protrusions.

The deck 12 has rounded lateral edges 16. The convex lower surface 12b extends into the edges 16. Both sides of the deck 12 are curved along their full lengths. The front and rear deck boxing (or ends of the deck 12) are also curved. In other words, the rounded edges 16 extend continuously all the way around the periphery of the deck 12.

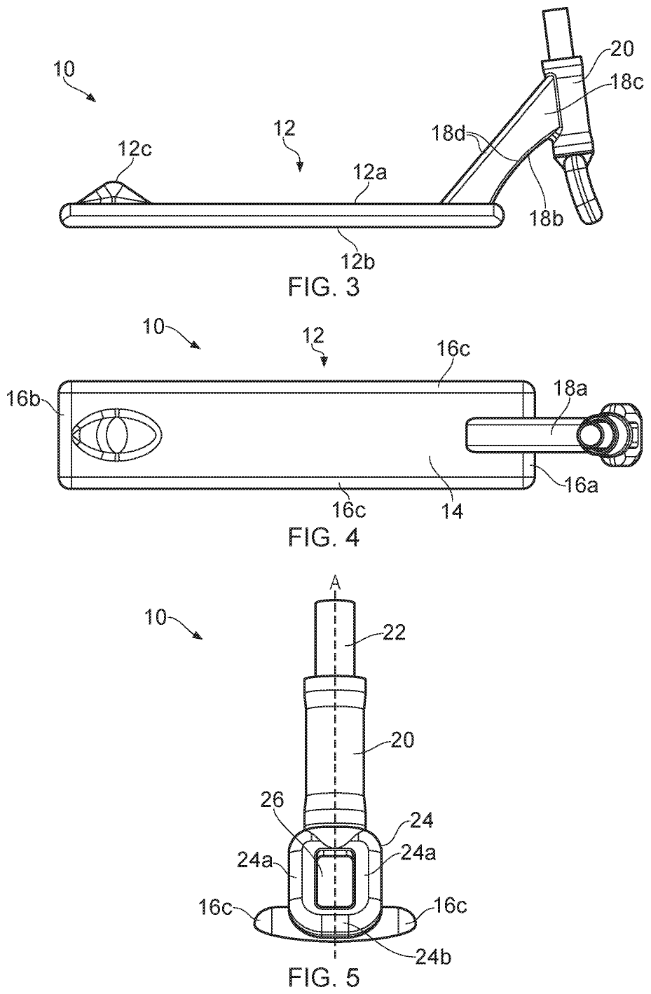

The front and rear edges 16a, 16b (seen in FIG. 3) are substantially semi-circular in profile. The side edges 16c are shaped differently. Each side edge 16c has a first curvature leading out of the underside 12b. Each side edge also has a second curvature, leading out of the upper surface 12a. The first and second curvatures of the side edges 16c meet and blend into each other between the upper and lower surfaces 12a, 12b.

The approximate weight of the scooter including handle bars is 3.5 kg. In terms of dimensions, the area of the upper surface 12a is 20.5″×4.75″ (approximately 52 cm×12 cm). The deck 12 has a corresponding thickness of about 2.6 cm, measured along plane A. The thickness of the deck at plane A is about double the thickness of the deck at its side edges. The thickness of the deck 12 reduces towards each of the side edges 16c. The thickness of the deck 12 at the side edges 16c is about 1.3 cm, taken between a plane of the upper surface 12a and a plane across the widest part of the deck 12. In other words, where the first and second curvatures meet on each side edge 16c is about halfway between the upper and lower surfaces 12a, 12b. A smaller version of the deck having upper surface 12a dimensions of 18.0″×4.50″ (approximately 46 cm×11.5 cm) is also contemplated.

A neck 18 extends centrally from the front end of the deck 12. The neck is connected to the upper surface 12a at the opposite end to the dummy brake. The neck 18 has substantially flat top and side surfaces 18a, 18c and a slightly concave bottom surface 18b. Edges 18d of the neck 18 are rounded. The neck 18 is integrally formed with the deck 12 in this embodiment.

A head tube 20 is connected to the neck 18. In this embodiment, the head tube 20 is integrally formed with the neck 18. The head tube 20 is substantially cylindrical in shape. The head tube 20 is oriented slightly off-vertical, with its lower end angled away from the deck 12. The angle complements the length of the column 22, so that when handle bars (not shown) are attached, the handle bars are positioned above the front end of the deck 12. The angle is in the region of 10° off-vertical in this embodiment.

A column 22 is mounted through a through aperture (not visible) in the head tube 20. The column 22 is freely rotatable within the head tube 20. The column 22 runs parallel to the head tube 20. The column 22 extends upwardly away from the deck 12 and head tube 20, but the full length of the column is not shown. An upper end of the column (not illustrated) is adapted to receive a set of handle bars. In particular, it is compatible with any make of scooter bar. The length of the column 22 is suitable for the handle bars to be situated at hand height, when a rider is standing on the deck 12.

Conventional fixing means can be used to attach the handle bar to the column. The head tube 20 and column 22 are suitable for use with a 1⅛″ size headset (approximately 2.86 cm). The headset is functions as a bearing which smooths rotation of the column 22 within the head tube.

A foot 24 is provided at a lower end of the column 22. A smooth collar 22a is provided on the column 22 to reinforce front and rear connections with the foot 24. The foot 24 is wider than the head tube 20 when viewed from the front (see FIG. 5). The side profile of the foot 24 shows that it curves outwardly from the deck 12 (see FIG. 3). The foot 24 is substantially O-shaped when viewed from the front (see FIG. 5).

However, the foot 24 does include rounded corners. An inner portion of the foot 24 has a through aperture 26. The aperture 26 has a cross-section of a rounded rectangle. An outer perimeter of the foot 24 is a rounded rectangle, when viewed from the front (FIG. 5).

The foot 24 comprises two upright members 24a and a horizontal bar 24b. The horizontal bar 24b is in the same plane as the deck 12 (see FIG. 5). The upright members 24a effectively imitate a forked section of a wheeled scooter. The bar 24b is integrally formed with the upright members 24a, forming a fused unit. The upright and horizontal members 24a, 24b are rounded on all sides. The foot 24 is also rounded where the horizontal member 24b transitions into the uprights. The foot 24 is also rounded where the uprights transition into the collar 22a.

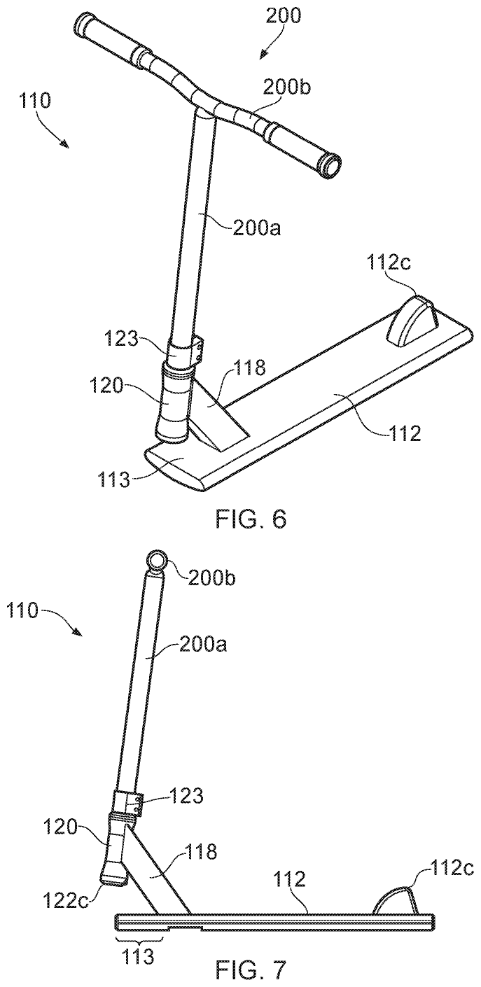

Referring now to FIGS. 6 to 8, a second embodiment of a trampoline scooter is indicated generally at 110. The features of the scooter 110 are generally the same as the first embodiment of a scooter 10 above, with the differences described below. Where possible, like reference numerals are used for like features between embodiments.

The scooter 110 is made of metal in this embodiment. Conventional manufacturing techniques may be used to form the scooter. The weight and dimensions of the scooter 110 may be different to the first embodiment.

The scooter 110 includes an elongate deck 112. The deck 112 includes a wedge-like member 112c towards a rear end of the deck 112. The member 112c is similar in shape to a shark fin. The wedge-shaped member 112c has a curved or convex lead face (forward-facing) and a substantially linear trailing face (rearward-facing). The tip, where the lead face transitions into the trailing face, is rounded. Side faces of the member 112c are substantially flat or planar. Rounded edges are provided where the side faces meet the lead and trailing faces. The wedge-shaped member imitates the shape of a brake on a normal scooter. The dummy brake is not flexible in this embodiment, but may have some flex in other embodiments.

A head tube support or neck 118 is connected to the upper surface of the deck 112. The support 118 is connected near a front end of the deck 112. The connection is substantially equidistant between the sides of the deck 112. The connection is inset from the rounded edge at the front of the deck 112. In this embodiment, the neck 118 is welded to the deck 112. In other embodiments, the neck 118 may be integrally formed with the deck 112.

A head tube 120 is connected at the other end of the neck 118. The connection is made at the side of the head tube 120. The head tube 120 may be integrally formed with the neck 18. Other features of the head tube are similar to the first embodiment.

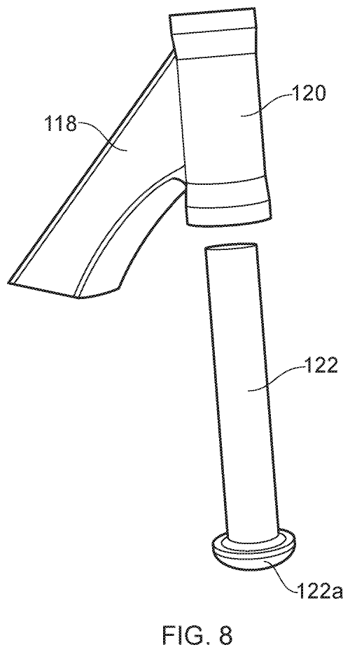

A column 122 (see FIG. 8) is mounted in the head tube 120. The column 122 is freely rotatable within the head tube 20. The column 122 extends upwardly away from the deck 112 and head tube 120. The lower end of the column 122 includes a nub or nub fork 122a. In other words, there is substantially no fork for engaging a trampoline.

Note that in FIG. 8 the deck and handle bars are hidden from view for clarity only.

Handle bars, indicated generally at 200, are attached to an upper end of the column 122. The handle bars 200 include a steering column 200a and a cross-bar 200b with grips at either end. A clamp 123 is provided around the steering column 200a where is connects to the column 122. The clamp 123 is provided next to the upper end of the head tube 120. The column 122a allows the handlebars 200 to rotate as they would for a normal scooter.

A lower end 122c of the column 122 terminates substantially at or near the bottom of the head tube 120. In other embodiments, the column may terminate in the head tube, as long as enough of the column is in the head tube for the scooter to be useable. The bottom of the column 122 is therefore disposed higher than the deck 112. In use, this means that the column does not engage a trampoline.

The front end of the deck 112 is disposed vertically below the head tube 120 and column 122. The front end of the deck 112 is disposed ahead of the neck-to-deck (or deck-to-neck) connection area. This effectively provides a substitute for a foot, since there is no foot on the column 122. The convex lower surface of the deck is the only trampoline-engaging component during normal use.

The above embodiments are exemplary only, and other embodiments are contemplated. For example, a solid ball with a suitable housing or connection means may be provided as a foot. The ball may be spherical, or at least hemispherical. The ball may be around 110 mm in diameter, and may be wider than the head tube. The ball may be made of plastic or rubber. The ball would provide even distribution of pressure in all direction when engaged with a trampoline. The deck length and/or width can each be independently selected to be any suitable size.

Furthermore, whilst the trampoline scooter may be constructed substantially as shown, it may also be constructed with another known scooter design in mind. For example, the weight and/or dimensions (including shape) of each of the deck, the neck and/or the foot are examples of parameters that may be customised to approximate the weight distribution and feel of a wheeled scooter, to make practising stunts as realistic as possible. The upper surface of the deck can be slightly concave and curve inwardly from each side towards the underside by about 3°.

The scooter parts may be provided as a kit, optionally with handle bars, for a user to assemble. A rubberised grip coating may be used on the upper surface of the deck. A tungsten carbide coating may be used on any trampoline-engaging element of the scooter. The underside may comprise a removable plate and corresponding means for connecting the plate to the deck.

The embodiments described above are provided by way of example only, and various changes and modifications will be apparent to persons skilled in the art without departing from the scope of the present invention as defined by the appended claims.

1. A trampoline scooter comprising
an elongate deck which comprises an upper surface, a convex lower surface, and rounded lateral edges provided between the upper and lower surfaces for engaging a trampoline,
a head tube connected to the elongate deck, and
a column disposed through the head tube, wherein an upper end of the column extends beyond the head tube for receiving a set of handle bars,
wherein at least a portion of a front end of the elongate deck is positioned underneath the head tube and the column such that said portion of the front end of the deck is vertically below the head tube and column when the trampoline scooter is upright.

2. (canceled)

3. (canceled)

4. The trampoline scooter of claim 1, wherein the head tube connection to the elongate deck is spaced or inset from the rounded lateral edge at the front end of the elongate deck.

5. The trampoline scooter of claim 1, wherein a lower end of the column is disposed or terminates above a lateral plane of the elongate deck.

6. The trampoline scooter of claim 1, wherein the upper surface of the elongate deck includes an integral protrusion or integral raised member as an imitation brake.

7. (canceled)

8. The trampoline scooter of claim 1, further comprising a set of handle bars connected to the column, and wherein the set of handle bars is integrally formed as part of the column or wherein the set of handle bars is selectively connected to the column by a connection member.

9. The trampoline scooter of claim 1, wherein the rounded lateral edges form a continuous periphery around a front, rear and sides of the elongate deck.

10. The trampoline scooter of claim 1, wherein a foot is not provided on the column, and wherein the positioning of said portion of the front end of the elongate deck under the column enables use of said portion of the front end of the elongate deck as a foot.

11. The trampoline scooter of claim 1, wherein the elongate deck comprises a plate receiving area for releasably holding a plate which, when connected, forms at least part of the convex lower surface of the elongate deck.

12. The trampoline scooter of claim 1, wherein the upper surface of the elongate deck includes, or is at least partly covered by, a grip layer comprising a rubberised material, a rough surface, or grip tape.

13. The trampoline scooter of claim 12, wherein the upper surface of the elongate deck includes an integral protrusion or integral raised member as an imitation brake, and wherein the grip layer covers substantially all of the upper surface of the elongate deck but not the imitation brake.

14. (canceled)

15. The trampoline scooter of claim 1, wherein the upper surface of the elongate deck is substantially concave in shape.

16. (canceled)

17. The trampoline scooter of claim 1, wherein the convex lower surface of the elongate deck is curved about a longitudinal axis of the elongate deck.

18. (canceled)

19. (canceled)

20. (canceled)

21. (canceled)

22. (canceled)

23. (canceled)

24. (canceled)

25. (canceled)

26. (canceled)

27. (canceled)

28. A kit of parts for a trampoline scooter, the kit comprising:
an elongate deck which comprises an upper surface, a convex lower surface, and rounded lateral edges provided between the upper and lower surfaces for engaging a trampoline;
a head tube connected or connectable to the elongate deck; and
a column which is adapted to fit through the head tube, wherein when in use an upper end of the column extends beyond the head tube, wherein an upper end of the column is adapted for receiving a set of handle bars; wherein either:
a) at least a portion of a front end of the elongate deck is positioned underneath the head tube such that the front end of the deck is vertically below the head tube when the trampoline scooter is upright; or
b) a lower end of the column includes a foot which is selectively engageable with the trampoline during use, wherein at least a portion of the foot is disposed adjacent to a front end of the elongate deck when the column is fitted through the head tube.

29. (canceled)

30. (canceled)

31. (canceled)

32. A trampoline scooter comprising:
an elongate deck which comprises an upper surface, a convex lower surface, and rounded lateral edges provided between the upper and lower surfaces for engaging a trampoline;
a head tube connected to the elongate deck; and
a column disposed through the head tube, wherein one end of the column comprises a foot which is selectively engageable with the trampoline during use, wherein at least a portion of the foot is disposed adjacent to a front end of the elongate deck, and wherein the other end of the column extends beyond the head tube for receiving a set of handle bars.

33. The trampoline scooter of claim 32, wherein the foot comprises a substantially smooth surface for engaging the trampoline, and/or wherein the foot comprises a tungsten carbide surface for engaging the trampoline.

34. The trampoline scooter of claim 32, wherein the foot comprises at least one upright member and a horizontal member integrally formed with the at least one upright member, wherein the horizontal member is disposed in substantially a same plane as the elongate deck, wherein the horizontal member comprises rounded first and second ends and rounded sides between the first and second ends for engaging the trampoline.

35. The trampoline scooter of claim 34, wherein the foot comprises at least two upright members, and the horizontal member joins distal ends of the at least two upright members together to form a fused unit.

36. The trampoline scooter of claim 32, wherein the foot curves away from an axis of the column with increasing distance from the head tube.

37. The trampoline scooter of claim 32, wherein the foot comprises a ball, wherein the ball is made of solid plastic or rubber.

38. The trampoline scooter of claim 32, wherein the convex lower surface is curved about a longitudinal axis of the elongate deck.
